(19) United States
(12) Patent Application Publication
(10) Pub. No.: US 2026/0256158 A1
(43) Pub. Date: Sep. 3, 2026

(54) METHODS FOR TREATMENT OF MILK AND CREAM

(71) Applicant: MilkWays Holding B.V., Joure (NL)

(72) Inventor: Diederick Joost Servaes BRASSER, Joure (NL)

(21) Appl. No.: 18/872,793

(22) PCT Filed: Jun. 6, 2023
(86) PCT No.: PCT/NL2023/050312

§ 371 Date: Dec. 6, 2024

(30) Foreign Application Priority Data
Jun. 7, 2022 (WO) PCT/NL2022/050311

(51) Int. Cl. A23B 11/145; A23B 11/123; A23B 11/30

(52) U.S. Cl. CPC A23B 11/145; A23B 11/123; A23B 11/30

(57) ABSTRACT

The invention relates to method of treating milk and/or cream comprising concentration and/or bactofugation of milk, pasteurization of the milk and/or cream, cooling the pasteurized milk and/or cream to a temperature of −2° C. to 1° C. and storing the cooled milk and/or cream under aseptic conditions at a temperature of −2° C. to 1° C. The invention further relates to methods for increasing the storage life of milk and/or cream comprising such treating of milk and/or cream and to milk and cream treated with such methods.

### FIELD OF THE INVENTION

The invention relates to the field of treatment of fresh milk or cream, in particular treatment to increase the storage life of fresh milk or cream and concentrated fresh milk.

### BACKGROUND OF THE INVENTION

Increasing the storage life of milk or cream by subjecting the milk or cream to heat treatment, in particular pasteurization and sterilisation, that inactivate spoilage and pathogenic microorganisms has been carried out for decades.

In order to increase the storage life of milk at ambient temperature to multiple days, milk must be heated to temperatures higher than are achieved during pasteurization, i.e. temperatures of above 100° C. Disadvantages of treatment at such high temperatures are that milk undergoes several changes, such as changes in pH, protein denaturation, calcium precipitation and casein modification. For instance, a major disadvantage of these milk products having the improved shelf life obtained by the high thermal treatment processes is that the milk cannot be used for other purposes than as a liquid for direct consummation. In particular, high thermal treatment denatures the milk whey proteins in such a way that processing of the milk into other dairy products is greatly reduced. Such milk can for example no longer be used for making traditional cheeses by renneting and fermentation.

In order to increase storage beyond several days and maintain the possibility for further processing of the milk, it is known to heat treat the milk at lower temperatures, such as by pasteurization which is typically performed at 72° C. for 15 seconds, followed by storage of the pasteurized milk at a temperature of 4° C. This way it is possible to obtain a shelf life of approximately 18-20 days. Unlike milk that has been treated under high temperature, pasteurized milk is still suitable for production of most dairy products. In view thereof, pasteurized milk is included in the definition of “fresh milk”.

WO 2016/204614 describes a method to transport liquid milk during a supply chain time of more than 10 days. In particular it is described that a storage period of at least 40 days is achieved if the temperature of the liquid milk is kept at a temperature of less than 2° C. during at least 90% of the duration of the supply chain time.

Further known strategies to increase storage life of milk are to physically remove spoilage and pathogenic microorganisms from fresh milk for example by centrifugation and/or (micro) filtration. It has been described that more than 90% of microorganisms in milk can be removed using such method so that storage life of fresh milk can also be increased by about 10 days.

The majority of milk is produced in areas which are located far from locations where milk is used for consumption and/or preparation of dairy products so that the milk has to be transported over long distances, e.g. by shipping, which is a cost-effective, but time-consuming transportation method. In addition, due to an imbalance between milk production and consumption of milk and dairy products, long term storage of fresh milk is desired. Therefore, there remains a need in the art for improved methods of treatment of fresh milk, in particular to extend the storage life thereof.

### SUMMARY OF THE INVENTION

It is an object of the present invention to provide methods for treatment of milk or cream that overcome one or more of the disadvantages of known methods discussed herein above. In particular, it is an objection of the invention to provide methods for treatment of milk or cream that increase the storage life of the milk or cream, in particular fresh milk or cream.

The invention therefore provides in a first aspect a method of treating milk, the method comprising:
concentration of the milk to reduce the volume with at least 25%;
pasteurization of the concentrated milk;
cooling the pasteurized milk to a temperature of −2° C. to 1° C.; and
storing the cooled milk under aseptic conditions at a temperature of −2° C. to 1° C.

Also provided is a method of treating cream, the method comprising:
pasteurization of the cream;
cooling the pasteurized cream to a temperature of −2° C. to 1° C.; and
storing the cooled cream under aseptic conditions at a temperature of −2° C. to 1° C. In preferred embodiments, the method comprises skimming of milk to obtain the cream.

Also provided is a method of treating concentrated milk and/or cream, wherein the concentrated milk has been treated to reduce the volume with at least 25% as compared to the raw milk, the method comprising:
pasteurization of the concentrated milk and/or cream;
cooling the pasteurized milk and/or cream to a temperature of −2° C. to 1° C.; and
storing the cooled milk and/or cream under aseptic conditions at a temperature of −2° C. to 1° C.

In some embodiments, the method further comprises centrifugation to reduce the fat content and/or bactofugation to reduce thermoresistant microorganisms and spores thereof, preferably prior to concentration of the milk.

In a second aspect, the invention provides a method of treating milk, the method comprising:
bactofugation of milk;
pasteurization of the bactofuged milk;
cooling the pasteurized milk to a temperature of −2° C. to 1° C.; and
storing the cooled milk under aseptic conditions at a temperature of −2° C. to 1° C.

In preferred embodiments, the method further comprises concentrating the milk, preferably following bactofugation and prior to pasteurization of the bactofuged milk, preferably to reduce the volume with at least 25, more preferably with about 50% or more.

In a third aspect, the invention provides a method of treating milk, the method comprising:
bactofugation of milk;
concentration of the milk to reduce the volume with at least 25%;
pasteurization of the bactofuged and concentrated milk;
cooling the pasteurized milk to a temperature of −2° C. to 1° C.; and
storing the cooled milk under aseptic conditions at a temperature of −2° C. to 1° C.

In preferred embodiments, the cooled milk or cream is stored for at least 45 days, preferably more than 60 days.

In preferred embodiments, concentration of milk is performed by reversed osmosis, preferably at a temperature of 0-60° C., more preferably 0-5° C. or >35° C., more preferably 0-5° C., more preferably 0-2° C. In preferred embodiments, concentration is performed by reversed osmosis using a Reversed Osmoses (RO) installation. In preferred embodiments, concentration is performed by reversed osmosis using a Reversed Osmoses (RO) installation.

In preferred embodiments, concentration and/or bactofugation and pasteurization of milk and pasteurization of cream are performed within 48 hours after collection of the milk, preferably within 24 hours after collection of the milk.

In preferred embodiments, bactofugation is performed at 5000-15000 g, preferably at a temperature of 40-60° C.

In preferred embodiments, cooling following pasteurization is to a temperature of about 0.5° C. and storing is at a temperature of about 0.5° C.

In preferred embodiments, pasteurization is performed at a temperature of 60-80° C. for 10 seconds to 30 minutes for milk or 60-90° C. for 10 seconds to 30 minutes for cream, preferably 70-75° C. for 10-20 seconds.

In preferred embodiments, the method further comprises skimming of the milk prior to concentration and/or bactofugation, preferably at a temperature of 40-60° C.

In preferred embodiments, the milk is cooled to a temperature of 10° C. or less, preferably 6° C. or less after collection and prior to concentration and/or bactofugation.

In preferred embodiments, the method further comprises cooling the milk and/or cream to a temperature of 10° C. or less, preferably 6° C. or less, preferably about 2° C., prior to pasteurization and following concentration and/or bactofugation.

In preferred embodiments, the milk has a bacterial count of at most 300.000 cfu/ml prior to centrifugation and/or bactofugation, more preferably of at most 200.000 cfu/ml, more preferably of at most 100.000 cfu/ml, more preferably of at most 50.000 cfu/ml.

In preferred embodiments, said method comprises in the indicated order:
skimming of raw milk, preferably at a temperature of 40-60° C.;
bactofugation of the skimmed milk, preferably at 5000-10000 g at a temperature of 40-60° C.;
concentrating the bactofuged milk, preferably by reverse osmosis, preferably to reduce the volume with between 25 and 75%, preferable at a temperature of 0-5° C.);
cooling of the milk obtained in the previous step to a temperature preferably 6° C. or less, preferably about 2° C.;
pasteurization of the milk, preferably at a temperature of 60-80° C. for 10 seconds to 30 minutes;
cooling the pasteurized milk obtained in the previous step to a temperature of −2° C. to 1° C., preferably a temperature of about 0.5° C.;
storing the cooled milk under aseptic conditions at a temperature of 2° C. to 1° C., preferably a temperature of about 0.5° C.

In preferred embodiments, said method comprises in the indicated order:
skimming of raw milk, preferably at a temperature of 40-60° C., to obtain the cream fraction;
cooling of the cream obtained in the previous step to a temperature of 10° C. or less, preferably 6° C. or less, preferably about 2° C.;
pasteurization of the cream, preferably at a temperature of 60-90° C. for 10 seconds to 30 minutes;
cooling the pasteurized cream obtained in the previous step to a temperature of −2° C. to 1° C., preferably a temperature of about 0.5° C.;
storing the cooled cream under aseptic conditions at a temperature of 2° C. to 1° C., preferably a temperature of about 0.5° C.

In a further aspect, the invention provides a method for increasing the storage life of milk and/or cream, the method comprising treating the milk with a method according to the invention.

In a further aspect, the invention provides milk or cream treated with a method of the invention.

### DETAILED DESCRIPTION

The present inventors have previously found that pasteurized milk can be stored for prolonged periods of time, in particular up to 40 days, if it is kept at a temperature of less than 2° C. and it is treated aseptically. The inventors have now developed a novel treatment procedure for milk or cream wherein concentration of the milk, pasteurization of the milk or cream and long term storage of the milk or cream at a temperature of −2° C. to 1° C. are combined. As demonstrated in Example 1 herein, this procedure allows for a storage period of more than 100 days if the temperature of the milk is kept below 1° C. during essentially the whole time prior to its consumption or further processing. In particular, this Example demonstrates that a reduction in volume of milk of up to 50%, which inevitably also results in a corresponding concentration of any microorganisms or spores present in the milk, does not lead to a reduction of the storage life. The exceptionally long storage life that can be achieved with the treatment of the prevent invention in combination with the reduction in volume is in particular advantageous if the milk is produced in farms in areas which are located far from locations where milk or cream is used for consumption and/or preparation of dairy products so that the milk or cream has to be transported over long distances. This allows the transportation of milk and cream by shipping, which is a cost-effective, but time-consuming transportation method. Further, such long term storage enables to handle imbalances between milk production and variation in consumption of milk, cream and dairy products, i.e. the seasonality of milk production and consumption.

The inventors further investigated whether any bacteria in milk can potentially grow, and which spores can germinate, at such low temperatures of below 2° C. and in particular of between 0 and 1° C., via a literature search into the to value of the different bacteria, i.e. the highest temperature at which there is no growth for a specific bacterium. It was found that most spoilage or pathogenic bacteria that may be present in raw milk are not able to grow at temperatures below 1° C. The known exceptions are the psychrotrophic spoilage bacteria Pseudomonas spp (To −7.5° C.) and the pathogenic bacteria Listeria monocytogenes (To −0.4° C.) and Yersinia enterocolitica (To −1.3° C.). However, these three species cannot survive milk pasteurization and pasteurization is thus sufficient to eliminate these species from milk. However, as shown in Example 2 herein, the present inventors surprisingly found that a specific psychrotrophic bacteria with an unknown To can still grow in pasteurised milk stored at 0.5° C. for 8 weeks (56 days), e.g. if the raw milk has a relatively high SPC before pasteurization. Analyses of the milk, including DNA analysis, revealed that this bacteria was the gram positive aerobic spore-forming bacterium Paenibacillus Borealis. The fact that spores of Paenibacillus Borealis are able to germinate and/or the bacteria are able to grow in milk at 0.5° C. was unknown before the present invention. The inventors therefore set out to further develop a method to avoid Paenibacillus Borealis spore germination and/or Paenibacillus Borealis bacterial growth by a combination of bactofugation and/or concentration, followed by pasteurization and cooling to a temperature of below 1° C.

In a first aspect, the invention therefore provides a method of treating milk, the method comprising:
concentration of the milk to reduce the volume with at least 25%;
pasteurization of the concentrated milk;
cooling the pasteurized milk to a temperature of −2° C. to 1° C.; and
storing the cooled milk under aseptic conditions at a temperature of −2° C. to 1° C.

In a further aspect, the invention therefore provides a method for storing milk, the method comprising:
concentration of the milk to reduce the volume with at least 25%;
pasteurization of the concentrated milk;
cooling the pasteurized milk to a temperature of −2° C. to 1° C.; and
storing the cooled milk under aseptic conditions at a temperature of −2° C. to 1° C.

In some embodiments, the method further comprises bactofugation of the milk, preferably prior to concentration of the milk.

In a further aspect, the invention therefore provides a method of treating cream, the method comprising:
pasteurization of the cream;
cooling the pasteurized cream to a temperature of −2° C. to 1° C.; and
storing the cooled cream under aseptic conditions at a temperature of −2° C. to 1° C.

In some embodiments, the method comprises skimming of milk, in particular fresh milk, to obtain the cream. In other embodiments, the cream is obtained from fresh milk by skimming.

In a further aspect, the invention therefore provides a method of storing cream, the method comprising:
pasteurization of the cream;
cooling the pasteurized cream to a temperature of −2° C. to 1° C.; and
storing the cooled cream under aseptic conditions at a temperature of −2° C. to 1° C.

In preferred embodiments, the method comprises skimming of milk, in particular fresh milk, to obtain the cream. In other preferred embodiments, the cream is obtained from fresh milk by skimming.

The steps of a method of the invention are carried out in the indicated order.

In a second aspect, the invention provides a method of treating milk, the method comprising:
bactofugation of milk;
pasteurization of the bactofuged milk;
cooling the pasteurized milk to a temperature of −2° C. to 1° C.; and
storing the cooled milk under aseptic conditions at a temperature of −2° C. to 1° C.

In a further aspect, the invention therefore provides a method for storing milk, the method comprising:
bactofugation of fresh milk;
pasteurization of the bactofuged milk;
cooling the pasteurized milk to a temperature of −2° C. to 1° C.;
storing the cooled milk under aseptic conditions at a temperature of −2° C. to 1° C.

In preferred embodiments, the method further comprises concentrating the milk, preferably following bactofugation and prior to pasteurization of the bactofuged milk, preferably to reduce the volume with at least 25, more preferably with about 50% or more.

The steps of a method of the invention are carried out in the indicated order.

In a third aspect, the invention provides a method of treating milk, the method comprising:
bactofugation of milk;
concentration of the milk to reduce the volume with at least 25%;
pasteurization of the bactofuged milk;
cooling the pasteurized milk to a temperature of −2° C. to 1° C.; and
storing the cooled milk under aseptic conditions at a temperature of −2° C. to 1° C.

In a further aspect, the invention therefore provides a method for storing milk, the method comprising:
bactofugation of milk;
concentration of the milk to reduce the volume with at least 25%;
pasteurization of the bactofuged and concentrated milk;
cooling the pasteurized milk to a temperature of −2° C. to 1° C.; and
storing the cooled milk under aseptic conditions at a temperature of −2° C. to 1° C.

The steps of a method of the invention are carried out in the indicated order.

As used herein, “to comprise” and its conjugations is used in its non-limiting sense to mean that items following the word are included, but items not specifically mentioned are not excluded. In addition the verb “to consist” may be replaced by “to consist essentially of” meaning that a compound or adjunct compound as defined herein may comprise additional component(s) than the ones specifically identified, said additional component(s) not altering the unique characteristic of the invention.

The articles “a” and “an” are used herein to refer to one or to more than one (i.e., to at least one) of the grammatical object of the article. By way of example, “an element” means one element or more than one element.

The word “approximately” or “about” when used in association with a numerical value (approximately 10, about 10) preferably means that the value may be the given value of 10 more or less 1% of the value.

The use of the alternative (e.g., “or”) should be understood to mean either one, both, or any combination thereof of the alternatives.

As used herein “milk” refers to any animal milk, in particular cow, sheep, goat, buffalo, camel, llama and deer. In preferred embodiments, the milk is cow's milk. Further, as used herein, “milk” is liquid milk, including milk that has been concentrated after obtaining the milk. As used herein “cream” refers to dairy cream, obtained from milk as defined herein. In preferred embodiments, the cream is cream obtained from cow's milk. In preferred embodiments, cream is obtained by skimming of raw milk within 48 hours after collection of the raw milk, preferably within 24 hours after collection of the raw milk.

“Fresh milk” or “fresh cream” as used herein preferably refers to milk or cream, respectively, that after collection has not been subjected to high temperature treatment, more in particular has not been subjected to treatment at a temperature of above 90° C., more in particular has not been subjected to treatment at a temperature of above 80° C.

It is preferred that milk that is treated with a method of the invention is high quality raw milk. As used herein quality of the raw milk refer to the total mesophilic bacteria count. In preferred embodiments, the milk that is treated with a method of the invention has a bacterial count of at most 300.000 cfu/ml prior to bactofugation, more preferably at most 200.000 cfu/ml, more preferably at most 100.000 cfu/ml, more preferably at most 50.000 cfu/ml. Similarly, it is preferred that cream that is treated with a method of the invention is high quality cream. As used herein quality of cream refer to the total mesophilic bacteria count. In preferred embodiments, the cream that is treated with a method of the invention has a bacterial count of at most 300.000 cfu/ml, more preferably at most 200.000 cfu/ml, more preferably at most 100.000 cfu/ml, more preferably at most 50.000 cfu/ml.

In preferred embodiments, a method of the invention comprises a step of concentrating the milk. Concentration is performed to reduce the volume of the milk, which is an important factor in reducing costs of the transport of milk, while essentially maintaining the dry matter content. As demonstrated in the Examples a reduction in volume of milk of up to 50%, which inevitably also results in a corresponding concentration of any microorganisms or spores present in the milk, does not lead to a reduction of the storage life as defined herein. A reduction in volume of about 50% while essentially maintaining dry matter content results in approximately a doubling of the dry matter content.

Preferably, concentration is performed prior to pasteurization. If a bactofugation step if performed, concentration is preferably performed between bactofugation and pasteurization. For instance, concentration is performed immediately following bactofugation in accordance with a method of the invention.

In preferred embodiments, said concentration of milk, with fat contents ranging between whole and skimmed milk, reduces the volume of the milk with at least 25%, more preferably at least 40%, more preferably with about 50% or more. In further preferred embodiments, said concentration reduces the volume of the milk with between 25% and 75%. In further preferred embodiments, said concentration reduces the volume of the milk with between 40% and 75%, more preferably between 40% and 65%, more preferably between 40% and 55%. In particular embodiments, said concentration reduces the volume of the milk with between 40% and 50%, such as about 50%. As detailed herein above, the amount of dry matter in the milk approximately stays the same during concentration such that the dry matter concentration approximately increases proportionally with the reduction of the volume of the milk. E.g. if the volume is reduced by about 50%, the dry matter content is approximately doubled.

In further preferred embodiments, the concentration is at least 2 times, meaning that the dry matter content is approximately doubled, more preferably 2-3.5 times, meaning that the dry matter content is approximately increased 2-3.5 fold. In further preferred embodiments, the concentration is 3-3.5 times, meaning that the dry matter content is approximately increased 3-3.5 fold. Said concentration is preferably preformed by reversed osmosis as described herein.

Concentration of milk can be performed using any method known in the art for this purpose, such as reversed osmosis, preferably at temperatures between 0° C. and 60° C., more preferably at a temperature of 0-5° C.

In preferred embodiments, concentration is performed by membrane filtration, including reversed osmosis, ultrafiltration and microfiltration, or by evaporation. In further preferred embodiments, concentration is performed by reversed osmosis. In further preferred embodiments concentration is performed by reversed osmosis using a Reversed Osmoses (RO) installation. Such installations are well known in the art. Any such suitable installation can be used.

In preferred embodiments, concentration of the milk is performed within 96 hours after collection of the milk, preferably within 72 hours, more preferably within 48 hours after collection of the milk. In further preferred embodiments, concentration of the milk is performed within 36 hours, more preferably within 24 hours after collection of the milk.

In some embodiments, a method of the invention comprises a step of bactofugation of milk, preferably fresh milk. “Bactofugation” is well known in the art and refers to a procedure to remove microorganisms and spores thereof from milk by centrifugation. Bactofugation is performed with a bactofuge, a centrifuge designed to separate microorganisms and spores thereof from milk because bacteria and bacterial, heat-resistant, spores have a higher density than milk. The microorganism and spore containing fraction from a bactofuge discharged as a slurry-like material which is referred to as bactofugate. Optionally, the bactofugate can be added again to milk, including the pasteurized milk of the present invention, after the bactofugate has been sterilized.

Bactofuges suitable for bactofugation of milk, in particular fresh milk, are known in the art. Examples of suppliers of bactofuges are TetraPak UK (Tetra Pak® Bactofuge) and Westfalia (GEA Westfalia CNB/CND/CNE bactofuges).

Bactofugation typically entails centrifugation of milk at a speed of e.g. 5000-15000 g. In some embodiments, bactofugation is performed at elevated temperatures, such as at a temperature of 40-60° C., or 45-55° C.

In preferred embodiments, bactofugation is performed within 96 hours after collection of the milk, preferably within 72 hours, more preferably within 48 hours after collection of the milk. In further preferred embodiments, bactofugation is performed within 36 hours, more preferably within 24 hours after collection of the milk.

A method of the invention may comprise a single bactofugation step or more than one bactofugation step. I.e. in some embodiments, the bactofugation step is repeated at least once, in particular repeated 1-3 times. In preferred embodiments said second and optionally further bactofugation steps are performed prior to pasteurization. In preferred embodiments, the bactofugation step is repeated once. If more than one bactofugation steps are performed, the milk is optionally cooled between the different bactofugation steps. Preferably said cooling is to a temperature of 10° C. or less, more preferably to a temperature of less than 8° C., preferably 6° C. or less, preferably about 2° C.

In one embodiment of the invention, the bactofugation comprises the use of at least one bactofuge. In further preferred embodiments, the bactofugation comprises the used of at least two bactofuges, in particular at least two bactofuges in series.

In preferred embodiments, a method of the invention comprises both a step of bactofugation of the milk and a step of concentration of the milk. In such embodiments, concentration of the milk is typically performed following bactofugation and prior to pasteurization of the bactofuged milk.

A method of the invention comprises a step of pasteurization of the concentrated and/or bactofuged milk or of the cream. “Pasteurization” is well known in the art and refers to a heat treatment at moderate temperature at which most of non-spore forming pathogenic organisms including bacteria, yeasts, and moulds, which may cause food poisoning are reduced to a level at which they do not constitute a significant health risk. In the absence of further antimicrobial treatment, pasteurization allows for a storage life of milk of approximately 18-20 days at 4° C.

Pasteurization of milk is performed following bactofugation and concentration, if both these treatment steps are performed in a method of the invention. If only concentration is performed, pasteurization is performed following concentration. If only bactofugation is performed, pasteurization is performed following bactofugation.

Pasteurization conditions are typically designed such as to effectively destroy the microorganisms Mycobacterium tuberculosis and Coxiella burnetii. Pasteurization can be ultra-high temperature (UHT) pasteurization or moderate or low temperature pasteurization. UHT pasteurization involves heating milk or cream typically to 138-150° C. Moderate or low temperature pasteurization typically involves heating milk or cream to temperatures of between about 63° C. and 85° C. The pasteurization conditions in a method of the invention are preferably such that the bactericidal effects are equivalent to heating the raw milk to 72° C. for 15 seconds in a continuous flow pasteurization or at 63° C. for 30 minutes in a batch pasteurization. These conditions may vary and a skilled person may easily, based on the above, understand what is meant by pasteurization.

In the case of cream, pasteurization is preferably performed within 1 day after the cream is obtained by skimming, preferably within 4 hours, more preferably 2 hours, more preferably 1 hour after the cream is obtained by skimming.

In preferred embodiments, pasteurization refers to a thermal treatment of the concentrated and/or bactofuged milk at a temperature of 60-80° C. for 10 seconds to 30 minutes or the cream at a temperature of 60-90° C. for 10 seconds to 30 minutes. Pasteurization may for instance be conducted by heating at a temperature of 71-74° C. for 15-30 seconds, heating at a temperature of about 63° C. for about 30 minutes, heating at a temperature of about 76° C. for 20 seconds, heating at a temperature of about 74° C. for about 25 seconds and heating at a temperature of about 72° C. for about 15-20 seconds for both milk and cream. Preferably this pasteurization step is conducted at 70-75° C. for 10-20 seconds, more preferably about 72° C. for about 15-20 seconds, more preferably at 72° C. for 15-20 seconds for milk or cream, which is also known as High Temperature Short Time (HTST) pasteurization. Additionally, pasteurization of cream may for instance be performed by heating at a temperature of 75-90° C. for 15-20 seconds.

Pasteurization entails the heating a composition such that the entire composition is held at the indicated temperature for the indicated time period. Pasteurization is typically performed by heating the milk or cream rapidly to the indicated temperature, such as 72° C., keeping it at this temperature for the indicated period of time, such as 15 seconds, and cooling it down immediately thereafter.

In preferred embodiments, pasteurization of the milk or cream is performed within 96 hours after collection of the raw milk, preferably within 72 hours, more preferably within 48 hours after collection of the raw milk. In further preferred embodiments, pasteurization is performed within 36 hours, more preferably within 24 hours after collection of the raw milk.

After pasteurization, the milk or the cream is cooled to a temperature of between −2° C. and 1° C. In preferred embodiments, the milk or the cream is immediately cooled to the temperature of between −2° C. and 1° C. Alternatively, the milk or the cream is immediately cooled after pasteurization, e.g. to below 8° C., such to 4° C., followed by cooling to a temperature of between −2° C. and 1° C. Said cooling to a temperature of between −2° C. and 1° C. is then preferably performed within 1 day, preferably within 12 hours, more preferably within 8 hours, more preferably within 4 hours, after said immediate cooling following pasteurization. Cooling can be performed using any cooling method known in the art, e.g. using ice water.

In preferred embodiments, said cooling to a temperature of between −2° C. and 1° C., either immediately after pasteurization or after an initial immediate cooling, is to a temperature of 0-1° C., more preferably about 0.5-1° C. In further preferred embodiments, said cooling is to a temperature of about 0.5° C.

In preferred embodiments, cooling following pasteurization is to a temperature of about 0.5-1° C. and storing is at a temperature of about 0.5-1° C. In further preferred embodiments, cooling following pasteurization is to a temperature of about 0.5° C. and storing is at a temperature of about 0.5° C.

In some preferred embodiments, the methods of the invention do not comprise heating the milk or cream to a high temperature, in particular not to temperatures above 100° C., preferably not to temperatures above 80° C. for milk or not to temperature above 90° C. for cream. In preferred embodiments, the milk or cream is not heated to temperatures above the temperature of the pasteurization. In particular, milk or cream that is treated in accordance with the invention is not sterilized. Optionally, however, sterilized additions can be added to the milk or cream treated in accordance with the invention, such as a sterilized bactofugate as described herein above.

In preferred embodiments, the milk that is subjected to concentration and/or bactofugation is skimmed milk. Skimming refers to the separation of milk into two parts, skimmed milk and cream. “Skimmed milk” generally refers to milk that has reduced fat content, in particular a fat content of less than 0.1% v/v fat. Methods for skimming of milk are well known in the art and entail the removal of the cream fraction from raw or whole milk. Skimming of milk can for instance be performed by centrifugation and removal of the less-dense cream. In preferred embodiments, skimming is performed at elevated temperature, e.g. at a temperature of 40-60° C., such as about 50° C. Cream as used herein refers to a milk product that has an increased fat content and typically is the cream fraction resulting from skimming of milk. Cream preferably has a fat content of at least 25 v/v % fat, more preferably 25-50 v/v % fat, more preferably 30-45 v/v % fat, such as about 40 v/v % fat.

A method of the invention may further comprises a homogenization treatment. A homogenization treatment results in that milk fat globules are purposely reduced in size and purposely dispersed uniformly through the rest of the milk as compared to freshly collected milk. In other, preferred embodiments, the milk that is treated in accordance with the invention is non-homogenised milk.

A method of the invention may comprise one or more further cooling steps, in particular cooling steps after collection and prior to any further treatment step, cooling of the concentrated and/or bactofuged milk or of the cream prior to pasteurization, or both.

In preferred embodiments, a method of the invention further comprises cooling the concentrated and/or bactofuged milk or the cream to a temperature of 10° C. or less. In preferred embodiments, the cooling step is cooling to a temperature of less than 8° C., preferably 6° C. or less, preferably about 2° C., prior to pasteurization.

In further preferred embodiments, a method of the invention further comprises cooling of the raw milk to a temperature of 10° C. or less, preferably 8° C. or less, preferably 6° C. or less, after collection and prior to concentration and/or bactofugation or prior to skimming if cream is treated in accordance with the invention.

In further preferred embodiments, a method of the invention further comprises both cooling of the raw milk to a temperature of 10° C. or less, preferably 6° C. or less, after collection and prior to concentration and/or bactofugation or prior to skimming and cooling the concentrated and/or bactofuged milk or of the cream to a temperature of 10° C. or less, preferably to a temperature of less than 8° C., preferably 6° C. or less, preferably about 2° C., prior to pasteurization.

A method of the invention comprises storing the cooled milk and/or cream under aseptic conditions at a temperature of −2° C. to 1° C. In preferred embodiments, said storing is at a temperature of 0-1° C., more preferably about 0.5-1° C. In further preferred embodiments, said storing is at a temperature of about 0.5° C.

In particular embodiments, the temperature of the milk and/or cream does not exceed 1° C. for more than 10% of the storage time, preferably not for more than 5% of the storage time, more preferably not for more than 2.5% of the storage time, more preferably not for more than 1% of the storage time. In preferred embodiments, the temperature of milk and/or cream does not exceed 1° C. for longer than 1 consecutive day, preferably not for 4 consecutive hours, preferably not for longer than 3 consecutive hours, preferably not for longer than 2 consecutive hours, preferably not for longer than 1 hour after the pasteurized milk and/or cream has been cooled. In particular embodiments, the temperature of milk and/or cream does not exceed 1° C. after the pasteurized milk and/or cream has been cooled. This can for instance be achieved by storing the milk and/or cream in a temperature controlled refrigerated unit at the desired temperature.

“Storage life” as used herein (also known as shelf-life) refers to the time during which the milk and/or cream can be stored at a specific temperature before spoilage occurs due to growth of microorganisms. As used herein, milk and/or cream treated in accordance with the invention is considered within the storage life if the total viable count is less than 300.000 colony forming units (cfu)/ml. Total viable count (TVC), is a quantitative estimate of the concentration of viable or live microorganisms such as bacteria, yeast and spores that are capable of growing into distinct colonies in a composition or sample.

As demonstrated in the Examples herein, milk treated and stored in accordance with the present invention has a storage life of more than 45 days. To the knowledge of the inventors a longer storage life of fresh milk has not been experimentally demonstrated before. In particular, the present inventors show that milk treated and stored in accordance with the present invention has a storage life of more than 99 days.

Hence, in preferred embodiments, the cooled milk and/or cream is stored for at least 45 days, preferably more than 50 days, more preferably more than 55 days. In other embodiments, the milk and/or cream can be stored for more than 60 days, more preferably more than 70 days, more preferably more than 80 days, more preferably more than 90 days, more preferably more than 100 days. In other embodiments, the milk and/or cream is stored for more than 60 days, more preferably more than 70 days, more preferably more than 80 days, more preferably more than 90 days, more preferably more than 100 days.

In a method of the invention the milk and/or cream is stored aseptically. Further, any processing steps that are performed after pasteurization and after cooling, such as filling, packaging and transferring of the milk and/or cream, are preferably performed under aseptic conditions, also referred to as aseptic processing. For instance, the milk and/or cream is preferably aseptically transferred between a container of the facility where a method of the invention is performed and/or the storage facility and a container for long distance transport. Further, milk and/or cream is preferably also aseptically transferred between a container for long distance transport and a container of the destination storage facility.

As used herein “aseptic conditions” refers to conditions free from living, in particular pathogenic or spoilage, microorganisms. Similarly, “aseptic processing” refers to processing by which the milk, cream or a milk product is processed, e.g. transferred, filled out and/or packaged in sterile container, in a way that sterility is maintained. Aseptic processing and containers are well known in the art and for example described in U.S. Pat. Nos. 3,678,955, 3,871,824, 3,918,678, 3,918,942 and 3,998,589.

The raw milk which is subjected to treatment in accordance with the present invention may be obtained from farms in any manner. Preferably the raw milk is relatively fresh and obtained by applying hygienic methods and equipment at the farm and during transport to the facility at which the treatment is performed. In preferred embodiments, all steps in a method of the invention up to and including cooling to a temperature of −2° C. to 1° C. following pasteurization, preferably to a temperature 0° C. to 1° C., more preferably 0.5° C. to 1° C., such as about 0.5° C., are performed within 96 hours after collection of the milk, preferably within 72 hours, more preferably within 48 hours after collection of the milk. In further preferred embodiments, all steps in a method of the invention up to and including cooling to a temperature of −2° C. to 1° C. following pasteurization are performed within 36 hours, more preferably within 24 hours after collection of the milk.

A method of the invention may comprise further steps, such as conventional steps in milk processing. For instance, during storage, the containers containing the treated milk can e.g. be stirred, shaken or turned over regularly, e.g. every 2 hours, half day, day or 2 days, or continuously to prevent creaming of the milk and sedimentation. Similarly, the during storage, the containers containing the treated cream can e.g. be stirred, shaken or turned over regularly, e.g. every 2 hours, half day, day or 2 days, or continuously to prevent further creaming of the cream. Such regular or continuous stirring can be achieved by including stirrers in the containers. These stirrers need to be aseptically fitted into the containers. Further, after pasteurization and cooling the milk or cream can be filled into smaller containers, e.g. under laminar flow conditions.

In some embodiments, a method of the invention comprises a packaging step in which the milk or cream is packaged into a container. Preferably, the milk or cream is packaged under aseptic conditions, for example using an aseptic filling system. Such step preferably involves filling the milk or cream into one or more aseptic containers. Examples of useful containers are glass or plastic bottles, and plastic or waxed paper cartons.

When the milk or cream is transported during storage, the milk or cream may be transferred, in particular aseptically transferred, between a container of the treatment facility or one of the treatment facilities and the container used for transportation. WO 2016/204614 describes suitable containers for transport of milk and cream treated in accordance with a method of the invention and is incorporated herein by reference.

In preferred embodiments, a method of the invention comprises:
concentration of the milk to reduce the volume with at least 25%, preferably by reversed osmosis at a temperature of 1-5° C., more preferably 1-2° C.;
cooling of the milk obtained in the previous step to a temperature of 10° C. or less, preferably 6° C. or less, preferably 6° C. or less, preferably about 2° C.;
pasteurization of the milk at a temperature of 60-80° C. for 10 seconds to 30 minutes, preferable 10-20 s at 70-75° C.;
cooling the pasteurized milk obtained in the previous step to a temperature of −2° C. to 1° C., preferably a temperature of about 0.5-1° C., more preferably at a temperature of about 0.5° C.;
storing the cooled milk under aseptic conditions at a temperature of 2° C. to 1° C., preferably a temperature of about 0.5-1° C., more preferably a temperature of about 0.5° C.

In further preferred embodiments, a method of the invention comprises:
bactofugation of milk, preferably wherein bactofugation is performed at 5000-10000 g at a temperature of 40-60° C.;
cooling of the milk obtained in the previous step to a temperature of 10° C. or less, preferably 6° C. or less, preferably 6° C. or less, preferably about 2° C.;
pasteurization of the milk at a temperature of 60-80° C. for 10 seconds to 30 minutes, preferable 10-20 s at 70-75° C.;
cooling the pasteurized milk obtained in the previous step to a temperature of −2° C. to 1° C., preferably a temperature of about 0.5-1° C., more preferably at a temperature of about 0.5° C.;
storing the cooled milk under aseptic conditions at a temperature of 2° C. to 1° C., preferably a temperature of about 0.5-1° C., more preferably a temperature of about 0.5° C.

In further preferred embodiments, a method of the invention comprises:
bactofugation of milk, preferably wherein bactofugation is performed at 5000-10000 g at a temperature of 40-60° C.;
concentrating the bactofuged milk, preferably to reduce the volume with between 25 and 75%;
cooling of the milk obtained in the previous step to a temperature of 10° C. or less, preferably 8° C. or less, preferably 6° C. or less, preferably about 2° C.;
pasteurization of the milk, preferably at a temperature of 60-80° C. for 10 seconds to 30 minutes, preferable 10-20 s at 70-75° C.;
cooling the pasteurized milk obtained in the previous step to a temperature of −2° C. to 1° C., preferably a temperature of about 0.5-1° C., more preferably at a temperature of about 0.5° C.;
storing the cooled milk under aseptic conditions at a temperature of 2° C. to 1° C., preferably a temperature of about 0.5-1° C., more preferably a temperature of about 0.5° C.

In further preferred embodiments, a method of the invention comprises: skimming of raw milk, preferably at a temperature of 40-60° C.;
bactofugation of the skimmed milk, preferably wherein bactofugation is performed at 5000-10000 g at a temperature of 40-60° C.;
concentrating the bactofuged milk, preferably to reduce the volume with between 25 and 75%;
cooling of the milk obtained in the previous step to a temperature of 10° C. or less, preferably 8° C. or less, preferably 6° C. or less, preferably about 2° C.;
pasteurization of the milk, preferably at a temperature of 60-80° C. for 10 seconds to 30 minutes, preferable 10-20 s at 70-75° C.;
cooling the pasteurized milk obtained in the previous step to a temperature of −2° C. to 1° C., preferably a temperature of about 0.5-1° C., more preferably at a temperature of about 0.5° C.;
storing the cooled milk under aseptic conditions at a temperature of 2° C. to 1° C., preferably a temperature of about 0.5-1° C., more preferably a temperature of about 0.5° C.

In other preferred embodiments, a method of the invention comprises:
skimming of raw milk, preferably at a temperature of 40-60° C., to obtain the cream fraction;
cooling of the cream obtained in the previous step to a temperature of 10° C. or less, preferably 6° C. or less, preferably about 2° C.;
pasteurization of the cream, preferably at a temperature of 60-90° C. for 10 seconds to 30 minutes;
cooling the pasteurized cream obtained in the previous step to a temperature of −2° C. to 1° C., preferably a temperature of about 0.5° C.;
storing the cooled cream under aseptic conditions at a temperature of 2° C. to 1° C., preferably a temperature of about 0.5° C.

The methods of the invention advantageously allow milk that has not been subjected to high temperature treatment or cream to be stored for period of 100 days or longer, while still allowing for a high variety of applications of the milk or cream. I.e. milk or cream treated in accordance with the invention and stored for periods up to or longer than 55 days, or even up to or longer than 100 or 140 days can be used for direct consumption, as well as for the production of solid, semi-solid or liquid dairy products. Before the present invention it was unknown that pasteurization and storage at temperatures below 2° C., in particular below 1° C., would still allow for the germination of Paenibacillus spores and/or the growth of Paenibacillus. In particular, it was previously unknown that these spores and bacteria are able to germinate and/or grow in milk at temperatures as low as 0.5° C. Before the present invention, it was further unknown that concentration to reduce of the volume of milk by up to 50% or more, which inevitably also increases the bacterial count prior to pasteurization, is possible while maintaining the exceptionally long storage period with only the combination of pasteurization and storage at temperature below 2° C. and no further steps that aim to reduce microorganisms. It was further unknown that the combination of concentration and/or bactofugation, of pasteurization and of cooling to and storage at a temperature below 1° C. is sufficient for such exceptionally long storage life. The Examples herein demonstrate that in particular the combination of skimming, bactofugation, concentration to a volume of between 25 and 75% of the original volume, pasteurization and cooling to and storage at a temperature below 1° C. allow for the exceptionally long storage time. In particular, before the present invention, it was not considered necessary to combine these specific three steps, because the combination of pasteurization and storage at temperature below 2° C. were believed to be sufficient to prevent spoilage of milk. As detailed herein above, the exceptionally long storage life that can be achieved with the treatment of the prevent invention is in particular advantageous if the milk is produced in farms in locations which are located far from locations where milk is used for consumption and/or preparation of dairy products so that the milk has to be transported over long distances. This allows the transportation of milk by ships, which is a cost-effective, but time-consuming transportation method. As another example, such long term storage enables to handle imbalances between a relatively consistent milk production and variation in consumption of milk and dairy products, i.e. the seasonality of milk.

In another aspect, the invention provides milk that has been treated with a method of the invention. The invention further provides cream that has been treated with a method of the invention. Preferably, said milk or cream has been stored for at least 45 days, preferably more than 50 days, more preferably more than 55 days. In other embodiments, the milk or cream can be stored for more than 60 days, more preferably more than 70 days, more preferably more than 80 days, more preferably more than 90 days, more preferably more than 100 days. In other embodiments, the milk or cream is stored for more than 60 days, more preferably more than 70 days, more preferably more than 80 days, more preferably more than 90 days, more preferably more than 100 days.

Features may be described herein as part of the same or separate aspects or embodiments of the present invention for the purpose of clarity and a concise description. It will be appreciated by the skilled person that the scope of the invention may include embodiments having combinations of all or some of the features described herein as part of the same or separate embodiments.

The invention will be explained in more detail in the following, non-limiting examples.

### EXAMPLES

### Example 1

A test was performed with pasteurized milk in 500 ml carton packages. This milk was bactofuged to reduce the number of bacterial spores sufficiently and is packaged without recontamination with gram negatives. The milk was stored at 0.5° C. and was monitored for standard plate count (SPC) on a weekly basis and a number of times on organoleptic properties during the storage period of >140 days. The aims were to find out if microbiological quality stays at the desired level in concentrated, pasteurized milk and there is no growth of bacteria, and if organoleptic properties stay at the level of fresh pasteurized milk.

To carry out the test raw milk was stored at 4° C. for less than 24 hours and skimmed at 50° C. Subsequently, one batch of milk was bactofuged and one batch of milk was not subjected to bactofugation. Subsequently, batches of milk were concentrated to a concentration factor of approximately 3.8 at a temperature of 2° C. using a Reversed Osmoses (RO) installation, stored at 2° C., pasteurized at 72° C. for 15 seconds, filled under laminar flow conditions and stored aseptically in a temperature controlled refrigerated unit at a temperature of 0.5° C. during a period of more than 140 days. During the period of storage the milk was analysed on an interval basis on microbiological, physical/chemical and organoleptic properties.

Up until 140 days after storage, the microbiological analyses of the bactofuged and non-bactofuged milk did not show growth of psychrotrophic microorganisms.

Organoleptical testing revealed that there were no deviations found in appearance, smell and taste of the milk up until 140 days after storage, as compared to freshly pasteurized milk. The milk further scored better than milk prepared from milk powder in smell and taste. The milk was smooth in appearance, showed no signs of curdling or breaking, had no lumps and no grainy structure. The milk had a normal smell and taste and could be heated to boiling point without separation.

### Example 2

### Procedure

Raw milk was concentrated to a concentration factor of approximately 2 immediately after milking at a temperature of 37° C., cooled in ice-water, pasteurized at 72° C. for 20 seconds, filled under laminar flow conditions to prevent contamination with gram negative bacteria and stored in a temperature controlled refrigerated unit at a temperature of 0.5° C. during a period of more than 90 days. During the period of storage the milk was analysed on an interval bases on microbiological-, physical/chemical- and organoleptic properties.

The following steps were carried out:
Raw milk was concentrated immediately after milking using a Reversed Osmoses (RO) installation, which is connected to a milking carrousel to concentrate the milk directly after milking at a temperature of 37° C. This was carried out on day 1 between 8.00-10.00 hours.
The concentrated milk was collected in 25 litre stainless steel cans and cooled in an ice water bath with circulating waterflow.
The cans with cooled concentrated milk were transported in a box with ice-cubes to maintain or lower the temperature to the facility where it was further processed.

This was carried out on day 1 between 10.00 and 12.30 hours.
The concentrated milk was pasteurized at 72° C. for 20 seconds and additionally filled, under laminar flow conditions, in 500 ml PE bottles. The bottles were stored in ice-water. This was carried out on day 1 starting 14.00 hours.
The bottles, in ice-water, were transported back to the storage facility and stored in an dedicated refrigerated unit at a set temperature of 0.5° C.
The stored bottles were turned over every 2 days to prevent creaming of the milk.
The bottles of milk were sampled after arriving at the storage facility and analysed for microbiological status. Together with the samples of the concentrated milk before pasteurization, the concentrated milk directly after pasteurization and the quality results of the raw milk a full set of results was gathered to assess initial microbiological quality.
The stored bottles of milk were sampled every 4 weeks and analysed on bacterial growth by means of analysing the psychrotrophic count and the presence of Listeria. To assess the physical/chemical quality viscosity and pH were analysed every 4 weeks. The analyses were carried out at week 4, week 8 and week 13.
At week 8 and 13 the milk was tested organoleptically.

### Results

### Concentration Raw Milk

Based on the analyzed parameters lactose and protein of the concentrated milk compared to the average raw milk it was concluded that the concentration factor is approx. 1.7.

TABLE 1
fat, protein and lactose content of raw
milk prior to and after concentration

| | after | before |
|---|---|---|
| | concentration (%) | concentration |
| Fat (%) | 9.06 | 4.46 |
| Protein (%) | 5.47 | 3.34 |
| Lactose (%) | 7.77 | 4.51 |

### Quality of the Concentrated and Pasteurized Milk

SPC before pasteurization was relatively high: >300.000 cfu/ml. SPC after pasteurization was normal.

The week 4 sample gave a result for psychrotrophic count which was in line with expectations: <1 cfu/ml (see table 2). Only psychrotrophic count was analyzed as microbiological parameter during the interval testing because only gram negative psychrotrophic microorganisms (m.o.), are possibly able to grow at the chosen storage temperature and they need to be absent to make a storage period of 90 days possible.

The week 8 (table 3) and week 13 (table 4) samples showed that there was growth of psychrotrophic microorganisms to high counts. Analysis of SPC gave the same high results. The type of micro-organism was determined because it was unexpected that any micro-organism could grow at the low storage temperature of 5° C. DNA-typing showed that the high counts were the result of the outgrow of the gram positive aerobic spore-forming microorganism Paenibacillus Borealis. Listeria monocytogenes was not detected.

Indeed, the focus of the treatment of milk was originally set on eliminating gram negative psychrotrophic microorganisms such as Pseudomonas to be present in the milk. The fact that Paenibacillus Borealis is able to grow in milk stored at 0,5° C. was unknown.

TABLE 2
Microbiological and physical/chemical
results Concentrated milk Week 4

| | | |
|---|---|---|
| Listeria monocytogenes | Expectation: Not present | Result: Not present |
| Psychrotrophic m.o. | Expectation: <10 cfu/ml | Result: <1 cfu/ml |
| Acidity fat | | Result: 0.71 mmol/ |
| | | 100 grams |

TABLE 3
Microbiological and physical/chemical
results Concentrated milk Week 8

| | | |
|---|---|---|
| Listeria monocytogenes | Expectation: Not present | Result: Not present |
| Psychrotrophic m.o. | Expectation: <10 cfu/ml | Result: 2 × 10e6 |
| | | cfu/ml |
| Acidity fat | | Result: 0.77 mmol/ |
| | | 100 grams |
| pH | | Result: pH = 6.64 |

TABLE 4
Microbiological and physical/chemical
results Concentrated milk Week 13

| SPC | | Result: >3 × 10e6 |
|---|---|---|
| | | cfu/ml (6x) |
| Thermoresistent m.o. | | Result: 130-220 |
| | | cfu/ml |
| Listeria monocytogenes | Expectation: Not present | Result: Not present |
| Psychrotrophic m.o. | Expectation: <10 cfu/ml | Result: 17 × 10e6 |
| | | cfu/ml |
| Acidity fat | | Result: 0.88 mmol/ |
| | | 100 grams |
| pH | | Result: pH = 6.58 |
| | | (6.42) |

### CONCLUSIONS

It was unexpectedly found that Paenibacillus Borealis can grow at 0.5° C. if present in the milk. It is most likely that spores of Paenibacillus Borealis are able to germinate at temperature below 1° C., that Paenibacillus Borealis has a very long lag phase at the used storage temperature of 0.5° C. and that it will take several weeks before the log phase starts and growth will occur. 5 The presence of Paenibacillus will limit the possible period of storage of milk. Hence, storage of pasteurized (concentrated) milk for a period of 90 days or longer is only possible when the used (raw) milk is free from psychrotrophic aerobic spore-forming microorganisms such as Paenibacillus. Since Paenibacillus is often present in raw milk the risk of having psychrotrophic strains in the used milk is present. It must be ensured that the raw milk is of the needed microbiological quality or process steps to sufficiently reduce the number of spores in the are needed. Bactofugation of the milk prior to pasteurization will ensure this.

1. A method of treating milk and/or cream, the method comprising:
concentration of the milk to reduce the volume with at least 25% if the method is of treating milk;
pasteurization of the concentrated milk and/or cream;
cooling the pasteurized milk and/or cream to a temperature of −2° C. to 1° C.; and
storing the cooled milk and/or cream under aseptic conditions at a temperature of −2° C. to 1° C.

2. The method according to claim 1, wherein the cream is obtained by skimming the milk.

3. The method according to claim 1, wherein said concentration is performed by membrane filtration or evaporation.

4. The method according to claim 1, wherein said concentration is performed by reversed osmosis.

5. The method according to claim 1, wherein said concentration is performed at a temperature of 0-60° C.

6. The method according to claim 1, further comprising bactofugation of the milk prior to concentration of the milk.

7. The method according to claim 6, wherein said bactofugation is performed at 5000-15000 g, at a temperature of 50-60° C.

8. The method according to claim 1, wherein the concentration, and pasteurization are performed within 48 hours after collection of the milk.

9. The method according to claim 1, wherein the cooled milk and/or cream is stored for at least 45 days.

10. The method according to claim 1, wherein said cooling following pasteurization is to a temperature of about 0.5° C. and said storing is at a temperature of about 0.5° C.

11. The method according to claim 1, wherein the pasteurization of milk is performed at a temperature of 60-80° C. for 10 seconds to 30 minutes and/or the pasteurization of cream is performed at a temperature of 60-90° C. for 10 seconds to 30 minutes.

12. The method according to claim 1, further comprising skimming the milk prior to the concentration at a temperature of 50-60° C.

13. The method according to claim 1, wherein the milk and/or cream is cooled to a temperature of 10° C. or less after collection and prior to the concentration.

14. The method according to claim 1, further comprising cooling the concentrated milk and/or the cream to a temperature of 10° C. or less prior to pasteurization.

15. The method according to claim 1, wherein the milk has a bacterial count of at most 300.000 cfu/ml prior to concentration.

16. The method according to claim 1, wherein said method comprises in the indicated order:
skimming of raw milk;
bactofugation of the skimmed milk;
concentrating the bactofuged milk, to reduce the volume with between 25 and 75%;
cooling the milk obtained in the previous step to a temperature of 10° C. or less;
pasteurization of the milk;
cooling the pasteurized milk obtained in the previous step to a temperature of −2° C. to 1° C.;
storing the cooled milk under aseptic conditions at a temperature of 2° C. to 1° C.

17. The method according to claim 1, wherein said method comprises in the indicated order:
skimming raw milk to obtain the cream fraction;
cooling the cream obtained in the previous step to a temperature of 10° C. or less;
pasteurization of the cream;
cooling the pasteurized cream obtained in the previous step to a temperature of −2° C. to 1° C.;
storing the cooled cream under aseptic conditions at a temperature of 2° C. to 1° C.

18. A method for increasing the storage life of milk and/or cream, the method comprising treating the milk and/or cream with a method according to claim 1.

19. The method according to claim 5, wherein said concentrating is performed at a temperature of 0-2° C.

20. The method according to claim 14, comprising cooling the concentrated milk and/or the cream to a temperature of about 2° C.
